(19) United States
(12) Patent Application Publication
(10) Pub. No.: US 2024/0217355 A1
(43) Pub. Date: Jul. 4, 2024

(54) GROUND CONTACT UNIT

(71) Applicant: Easelink GmbH, Graz (AT)

(72) Inventors: Maximilian HOFER, Graz (AT); Martin ZAVERSKY, Graz (AT); Andreas SULZENBACHER, Graz (AT)

(21) Appl. No.: 18/558,799

(22) PCT Filed: May 3, 2022
(86) PCT No.: PCT/EP2022/061867

§ 371 Date: Nov. 3, 2023

(30) Foreign Application Priority Data
May 4, 2021 (DE) 10 2021 111 481.0

(51) Int. Cl. B60L 53/16; B60L 53/35; B60L 53/60; H02J 7/00

(52) U.S. Cl. CPC B60L 53/16; B60L 53/35; B60L 53/60; H02J 7/00304

(57) ABSTRACT

A ground contact unit for a vehicle battery charging system for the automatic conductive connection to a vehicle contact unit. The ground contact unit has a plate-shaped base body, at least one potential layer, and a plurality of contact areas which are arranged on an exposed charging surface of the base body against which the vehicle contact unit can come into contact, and which are assigned to the at least one potential layer. At least one protective assembly is assigned to the contact areas of the at least one potential layer. The at least one protective assembly has a current measuring unit provided in the current path for current measurement and a switch which is arranged in the current path and is controlled, among others, depending on the result of the current measuring unit.

### FIELD OF THE INVENTION

The invention relates to a ground contact unit for a vehicle battery charging system for the automatic, conductive connection of a vehicle contact unit.

### BACKGROUND

In electrically driven vehicles, for example plug-in hybrid vehicles and purely electric vehicles, the batteries of the vehicles have to be charged regularly, preferably after each journey. To this end, the vehicle is connected to an appropriate current source, a plug, a so-called type-2 plug, for example, which has to be plugged manually by a person into a corresponding socket on the vehicle being usually used.

Ground contact units for vehicle battery charging systems which are provided on the ground are furthermore known from the prior art, from document WO 2019/052962 A1, for example. The ground contact units can automatically establish a conductive connection with a corresponding vehicle contact unit provided on the vehicle to be charged, to charge the vehicle. The vehicle contact unit may be provided on the underbody of the vehicle, moving downward to establish the electrical contact with the ground contact unit.

For example, the ground contact unit is formed as a so-called matrix charging pad, as shown in document WO 2019/052962 A1. To this end, the ground contact unit comprises a plurality of contact areas arranged in a matrix-like manner, the contact areas being adapted to be contacted by means of the vehicle contact unit to establish an electrical connection between the ground contact unit and the vehicle contact unit. Depending on the point of application of the connector of the vehicle contact unit, the correspondingly occupied contact areas of the ground contact unit are activated to establish the electrical connection via these contact areas.

Typically, the occupied contact areas are activated by means of separate relays which are assigned to each contact area of the ground contact unit. This results in a so-called matrix relay which, among others, ensures the safety-relevant requirements as to the insulation path. The correspondingly high number of relays and the connection thereof however lead to correspondingly high costs, in particular if the relays used should switch reliably in the event of an occurring short circuit to interrupt the electric circuit.

Therefore, there is a need for a ground contact unit which meets the required conditions as to the operational safety as cost-effectively as possible.

### SUMMARY

According to the invention, the object is achieved by a ground contact unit for a vehicle battery charging system for the automatic conductive connection to a vehicle contact unit. The ground contact unit has a plate-shaped base body, at least one potential layer, and a plurality of contact areas which are arranged on an exposed charging surface of the base body against which the vehicle contact unit can come into contact, and which are assigned to the at least one potential layer. Furthermore, at least one protective assembly is assigned to the contact areas of the at least one potential layer, wherein the at least one protective assembly has a current measuring unit provided in the current path for current measurement and a switch which is arranged in the current path and is controlled, among others, depending on the result of the current measuring unit.

The basic idea of the invention is that the ground contact unit includes at least one protective assembly arranged in the current path. The protective assembly comprises the current measuring unit and the switch which are both arranged in the current path, so that the current in the current path can be measured and the switch can be switched depending on the measured current to interrupt the electric circuit, if necessary.

According to the invention, a potential layer means the potential of an outer conductor, i.e. a phase, or the potential of a neutral conductor. The at least one protective assembly can thus be assigned to at least one phase or to the neutral conductor.

In addition to the neutral conductor and the outer conductor, i.e. the respective phase, an “earthing” may furthermore be provided, i.e. a protective conductor.

In particular, the ground contact unit may thus also be configured for an electrical charging using direct current.

Generally, each phase, i.e. each outer conductor, and the neutral conductor may respectively have their own protective assembly, i.e. an appropriate switch provided in the respective current path, and a current measuring unit provided in the respective current path, which cooperate to interrupt the current path, if necessary.

In a three-phase AC system, the contact areas may thus be assigned to three potential layers serving as phases, wherein three or four protective assemblies are furthermore provided, more specifically for the respective outer conductor, i.e. the phases, and (optionally) for the neutral conductor.

Generally, the ground contact unit may however also be used for other current systems such as current systems having two phases or four phases, or precisely for DC systems.

Typically, corresponding relays are provided for the contact areas assigned to the outer conductors, i.e. the phases, and to the neutral conductor, to ensure a galvanic isolation, if this is necessary. These relays can be appropriately protected against high current intensities via the separately configured protective assembly as the associated currents are interrupted in time.

The protective assembly comprises the current measuring unit provided for current measurement, and the switch. As soon as the current measuring unit detects a current during current measurement which indicates a fault, the electric circuit is interrupted accordingly via the switch. In other words, a tripping case of the protective assembly occurs in which the protective assembly trips. The contact areas and any relays assigned to the contact areas are thus protected, so that they do not have to carry a short-circuit current or an overcurrent, for example.

Basically, the ground contact unit may comprise 168 contact areas, for example, which are arranged in a matrix so that each of the contact areas represents a matrix contact. In one embodiment, 156 switchable contact areas and 122 non-switchable contact areas, i.e. PE contact areas are provided. In principle, the number is flexible, so that there may be 120 or 80 contact areas, for example. The relays typically assigned to the contact areas ensure that an inactive contact area can be touched as it is galvanically isolated from the associated potential layer.

One aspect provides that the plurality of contact areas is assigned to exactly one potential layer, the contact areas assigned to the exactly one potential layer being assigned to only one protective assembly. In this respect, a plurality of contact areas of the ground contact unit may be assigned to an outer conductor, i.e. a phase, or to the neutral conductor. The respective contact areas belonging to the same phase or to the neutral conductor are at the same time assigned to exactly one protective assembly, if several protective assemblies are provided. This ensures that only one protective assembly is required per potential layer. The costs for the ground contact unit can be reduced accordingly, as all contact areas of one potential layer are additionally protected by only one protective assembly.

A further aspect provides that the protective assembly is set up to detect a short circuit, an impending overcurrent and/or an overcurrent, the protective assembly being set up to control the switch into its open position in case a short circuit, an impending overcurrent and/or an overcurrent has been detected. A control unit which is a superordinate control unit, for example, may be assigned to the protective assembly. The superordinate control unit can drive a plurality of protective assemblies simultaneously.

In particular, the control unit is part of a control and evaluation unit. In this respect, the current measuring unit of the respective protective assembly may forward the measured current in the current path to the control and evaluation unit which performs the evaluation to then drive the switch accordingly depending on the result of the evaluation, if a tripping case has been detected.

The protective assembly may be set up to detect a current curve and to determine characteristics of the detected current curve. The characteristics of the current curve may involve the shape of the current curve, i.e. the temporal course of the measured current intensity. A specific behavior related to a fault case can be derived from the course. Alternatively or additionally, a maximum value, in particular a global maximum or a local maximum, or a moving average over a defined period of time may be determined as characteristics and be used for evaluation. Basically, the temporal behavior of the measured current intensity may be used to detect a tripping case of the protective assembly in which the switch arranged in the current path trips to interrupt the current.

For example, the protective assembly is set up to perform an evaluation of the edges and/or of the level of the detected current curve and/or to recognize an occurring arc. The arc may occur when the connector of the vehicle contact unit shifts relative to the ground contact unit or a gap is formed between the respective contacts. An arc may also be generated due to a soiling of the contacts, an insufficient pressure force of the vehicle contact unit, or vibrations. The arc leads to a characteristic change in the current curve which can be detected accordingly by the protective assembly, in particular the current measuring unit. Due to the arc, high-frequency current components are formed which may be detected by the protective assembly, in particular the current measuring unit or the control and/or evaluation unit. As a result, the switch can be switched, for example to prevent an occurring arc, in particular before it is generated, or to reduce the harmful influence of an arc.

Basically, the arc detection may also be integrated in the vehicle contact unit.

With the edge detection, it may be detected whether an edge is present in the current curve and which type of edge it is so that it can be determined on the basis thereof whether there is a tripping case. The level detection may also be configured such that the mean value over a defined period of time, or the mean value of two successive measurements, or another statistical measure for the current intensity is used to be able to exclude possible measurement errors, i.e. short-term peaks or outliers of the measurement.

In the level detection, the measured current value can be compared with a threshold value used as a reference value, so that a possible tripping case occurs only if the threshold value has been exceeded. To effectively exclude a false alarm, the edge behavior of the measured current curve can also be taken into account, so that an edge detection is provided in addition to the level detection.

The edge detection and/or the level detection may be implemented in the control and/or evaluation unit. Alternatively, the edge detection and/or the level detection may also be implemented in the current measuring unit itself, so that the current measuring unit directly drives the switch.

Generally, two criteria can be combined which have to be met such that the protective assembly trips. This ensures that a measurement error does not cause a tripping of the protective assembly as there is a redundant evaluation, namely due to the two different criteria which have to be met. The two criteria can be based on different characteristics of the current curve, in particular characteristics which are independent of each other.

The protective assembly may comprise an operational amplifier circuit and/or a comparator and a shunt resistor and/or a Hall-effect sensor. The current value in the current path can thus be measured in a simple and cost-effective manner. The edge or level detection can in principle be realized by means of the shunt resistor and the comparator. An operational amplifier circuit may also be provided instead of the comparator. A Hall-effect sensor which is directly integrated in the current path may also be provided instead of the shunt resistor.

Furthermore, the switch may be a power semiconductor, in particular a MOSFET, a triac or an IGBT. The power semiconductors can be used to realize correspondingly high switching speeds, in particular below one microsecond. In this respect, in the event of tripping, for example in the event of a short circuit, the electric circuit can be interrupted within a few microseconds, so that the corresponding contact areas are de-energized. In this respect, the energy input into the contact areas may be kept very low, as a result of which corresponding protection is provided, in particular wear protection. Any relays of the ground contact unit do not have to carry the short-circuit current (for a long time), as the electric circuit has been interrupted correspondingly quickly.

The at least one protective assembly can be set up to determine a differential current. The differential current can be measured between two potential layers, for example between two outer conductors, i.e. two phases, or between a phase and the neutral conductor, or between the protective conductor and a phase of the neutral conductor. The differential current is generally also referred to as fault current, which is a leakage current.

Basically, when a fault occurs, for example a fault current, this fault is detected by the current measuring unit, and the switch is driven so as to interrupt the electric circuit within a few nanoseconds, in particular within a few 100 nanoseconds. The switching of the relay would here take much longer so that there would be a risk that the relay burns off or remains “stuck” in its closed position, which can thus be avoided. The high energy input into the contact areas and/or the relay is also prevented. The relay can switch almost load-free after tripping of the protective assembly, i.e. opening of the switch, as a result of which a galvanic separation, i.e. a galvanic isolation has been established in accordance with the standards.

According to a further embodiment, the ground contact unit has at least one additional switching unit, in particular a relay. The at least one additional switching unit is coupled to at least one of the contact areas such that the additional switching unit is adapted to electrically connect and disconnect the corresponding at least one contact area to/from the at least one potential layer assigned to the contact area, so that there is a galvanic isolation in the interrupted state. This results in the galvanic isolation of the corresponding contact area from the assigned potential layer conforming to standards, so that in the event of a fault, it is ensured that no current flows. The protection against contact is ensured accordingly, which is not possible by means of the switch designed as a power semiconductor.

As explained above, the additional switching unit can be switched load-free after the switch has previously been driven so as to interrupt the electric circuit.

The at least one additional switching unit is for example provided downstream of the protective assembly in the direction of current flow, in particular wherein the at least one additional switching unit is provided between the protective assembly and the contact areas. The current flows via the protective assembly to the respective contact areas, so that the additional switching unit is provided between the protective assembly and the contact areas, in particular downstream of the switch of the protective assembly. If the protective assembly trips, i.e. the switch interrupts the electric circuit, it is ensured that the additional switching unit was only briefly exposed to the high current intensity

Basically, the position of the relay is freely selectable.

One embodiment provides that only one additional switching unit is provided per potential layer. The corresponding additional switching unit may be provided directly behind the switch, i.e. downstream of the switch, so that all contact areas assigned to the potential layer are assigned to the one additional switching unit. If the one additional switching unit opens, all contact areas are thus simultaneously galvanically isolated from the assigned potential layer.

According to a further embodiment, the at least one protective assembly is assigned to a plurality of additional switching units, wherein each contact area has its own additional switching unit assigned thereto. This enables an individual galvanic isolation of the individual contact areas since an individual additional switching unit which can be driven accordingly is assigned to each contact area of a common potential layer.

For driving the at least one additional switching unit, a trigger circuit may be provided, which is set up to drive the at least one additional switching unit. The trigger circuit may be coupled to the superordinate control unit, in particular the superordinate control and/or evaluation unit, so that if a tripping situation of the protective assembly is detected, the trigger circuit already outputs an appropriate tripping signal to the at least one additional switching unit to ensure that the additional switching unit trips as promptly as possible, i.e. establishes the galvanic isolation.

Due to the protective assembly the switch of which switches correspondingly faster than the additional switching unit, it is ensured that the additional switching unit can switch load-free. Since the switch and the additional switching unit are nevertheless driven simultaneously, it is further ensured that the galvanic isolation is provided as early as possible, since the additional switching unit is also driven via the trigger circuit in the event of tripping.

It is thus ensured that in the cutoff state, the switching units assigned to the contact areas ensure basic protection and fault protection with an reinforced insulation with respect to the supply potential, i.e. the corresponding potential layer.

Furthermore, the switching units may be configured such that in the cutoff state, basic protection is ensured by insulation with respect to a supply potential, the contact areas assigned to the switching units being additionally previously grounded.

The protective assembly in particular comprises more than one switch, so that a switching module comprising a plurality of switches is provided. The plurality of switches may be arranged in parallel or anti-serially.

According to one embodiment, a surge protection device (SPD) is provided, which is arranged upstream of the protective assembly. The surge protection device ensures that the downstream components such as the protective assembly are effectively protected against an overvoltage. It can thus be ensured that the switch of the protective assembly can be configured as a semiconductor switch, for example a MOSFET, an IGBT or a triac.

Furthermore, an additional switching unit, in particular a main contactor, can be arranged between the surge protection device and the protective assembly. The main contactor is thus arranged in the area protected by the surge protection device. This results in the components arranged downstream of the main contactor having multiple protection, namely due to the surge protection device and the main contactor. These components are, among others, the protective assembly and the further components arranged downstream of the protective assembly.

In principle, areas of different overvoltage categories can be realized in this way, namely, due to the surge protection device, an area according to overvoltage category III (“OVC III”), in which the main contactor is arranged, and due to the main contactor, an area according to overvoltage category II (“OVC II”), in which, among other things, the protective assembly is provided. For example, overvoltage category III is assigned to a rated surge voltage of 4 kV, whereas overvoltage category Il is assigned to a rated surge voltage of 2.5 kV.

In this respect, the components arranged in the area assigned to overvoltage category Il can be configured relatively simpler, since these components only have to be designed for a rated surge voltage of 2.5 kV.

Depending on the design, the surge protection device could also protect the components of the protective assembly and other components downstream up to the voltage range of 2 kV or even lower.

A further aspect provides that the surge protection device comprises a diagnostic contact via which the surge protection device is connected in a signal-transmitting manner to a control and/or evaluation unit. By means of the diagnostic contact, diagnostic data providing information about the status of the surge protection device can be transmitted to the control and/or evaluation unit. The control and/or evaluation unit can then output a message to a user of the ground contact unit and/or take safety measures, such as driving the main contactor to interrupt a power supply via the main contactor.

Basically, a diagnostic function of the surge protection device can be implemented by means of the diagnostic contact, since it wears out to different degrees depending on the location and/or use and can therefore fail at different times. In this respect, the diagnostic contact can also be used to implement predictive maintenance of the surge protection device.

The surge protection device may have two galvanically isolated diagnostic contacts which are connected in a signal-transmitting manner to the control and/or evaluation unit.

In particular, the surge protection device may be a plug-in module which is connected to a main terminal of the ground contact unit.

In this respect, the surge protection device may have a plurality of terminals, in particular a plurality of terminals for different potential layers, for example the phases L1, L2, L3 and a neutral layer N. In addition, a terminal for a protective conductor potential may be provided.

It is basically provided that the current measuring unit measures a charging current in the current path. In this respect, charging current monitoring is implemented by the current measuring unit. Consequently, the current measuring unit can detect an event during a charging process, for example a short circuit occurring during charging, an overcurrent occurring during charging, and/or an impending overcurrent during charging. The corresponding event detected by means of the current measuring unit would result in a tripping of the relay.

However, due to the driving of the switch of the protective assembly, it is ensured that the charging current is interrupted quickly, in particular faster than the reaction time of a relay.

### BRIEF DESCRIPTION OF THE DRAWINGS

Further advantages and features of the invention will become apparent from the description below and from the drawings, to which reference is made and in which:

FIG. 1 shows a schematic top view of a ground contact unit according to the invention,

FIG. 2 shows a circuit diagram of the ground contact unit according to the invention in accordance with a first embodiment,

FIG. 3 shows a schematic representation of the circuit diagram of the ground contact unit according to the invention in accordance with a second embodiment,

FIG. 4 shows a diagram showing the course of the measured current over time, and

FIG. 5 shows a schematic representation of the circuit diagram of the ground contact unit according to the invention in accordance with a third embodiment.

### DETAILED DESCRIPTION

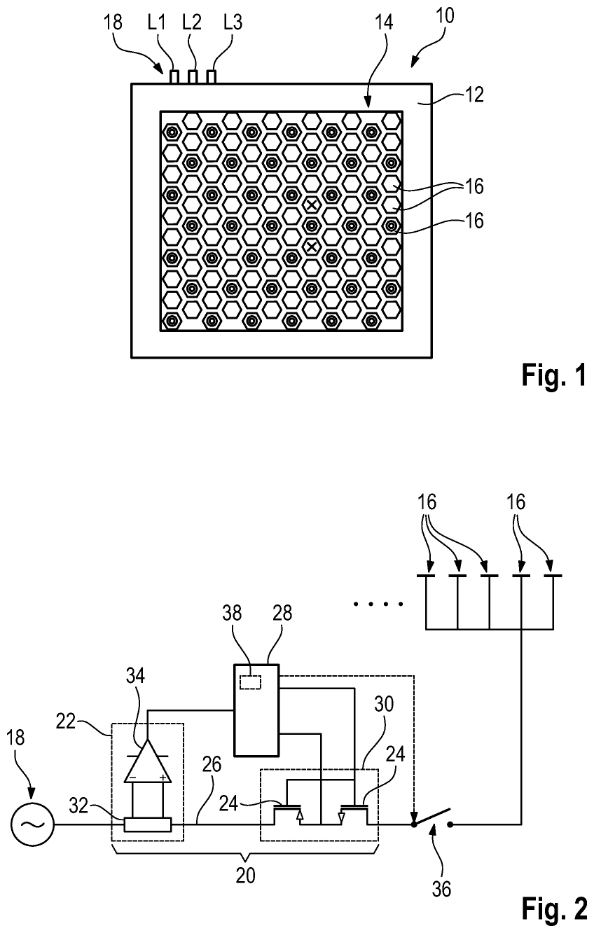

FIG. 1 shows a ground contact unit 10 for a vehicle battery charging system, which is used for the automatic conductive connection to a vehicle contact unit not shown here.

The ground contact unit 10 has a plate-shaped base body 12, which has an exposed charging surface 14 on which a plurality of contact areas 16 are arranged.

It is apparent from FIG. 1 that the several contact areas 16 are arranged in a matrix-like manner, the vehicle contact unit being adapted to come into contact with the respective contact areas 16 via its connector to establish the electrical connection to the ground contact unit 10.

The several contact areas 16 are assigned to at least one potential layer 18, wherein in the embodiment shown, it is a three-phase network system, so that three potential layers corresponding to the phases L1, L2 and L3 are provided, as well as one potential layer corresponding to the neutral conductor. In addition, a protective conductor may still be provided, which serves to earth the ground contact unit 10.

The plurality of contact areas 16 is assigned to the plurality of potential layers 18, so that different connection situations can be obtained for the vehicle contact unit, in particular depending on the respective orientation of the connector on the ground contact unit 10.

Furthermore, the several contact areas 16, in particular the potential layers 18 assigned to the contact areas 16, are electrically protected, a protective assembly 20 which is assigned to the contact areas 16 of the at least one potential layer 18 being provided for this purpose.

The protective assembly 20 according to a first embodiment is shown for one of the potential layers in more detail in FIG. 2, to which reference is made below.

The protective assembly 20 comprises a current measuring unit 22 and a switch 24, both of which are arranged in a current path 26 of the respective potential layer 18.

In this respect, the ground contact unit 10 comprises one protective assembly 20 per potential layer 18.

The protective assembly 20 is generally set up to detect a short circuit, an impending overcurrent, an overcurrent and/or a fault current, in particular during an ongoing charging process, i.e. when a charging current flows via the current path 26.

The protective assembly 20 is set up to control the corresponding switch 24 into its open position, if a short circuit, an (impending) overcurrent and/or a fault current has been detected.

In this respect, the at least one protective assembly 20 may be set up to detect a differential current. The differential current can be measured between two potential layers 18, for example between two outer conductors, i.e. two phases, or between a phase and the neutral conductor, or between the protective conductor and a phase or the neutral conductor.

To drive the switch 24 of the protective assembly 20, a control and/or evaluation unit 28 is provided in the embodiment shown, which is arranged between the current measuring unit 22 and the corresponding switch 24.

The control and/or evaluation unit 28 may be a superordinate control and/or evaluation unit which cooperates with all protective assemblies 20 of the ground contact unit 10, i.e. those of the other potential layers 18. In this respect, the one control and/or evaluation unit 28 may receive the measured currents of all current measuring units 22, whereupon the one control and/or evaluation unit 28 can drive all switches 24 assigned to the respective potential layers 18, if this is necessary.

Alternatively, it may also be provided that the current measuring unit 22 directly drives the assigned switch 24, which then moves into its open position to interrupt the electric circuit.

In the embodiment shown in FIG. 2, the protective assembly 20 further comprises a switching module 30 having two switches 24 arranged in an anti-serial manner. The switches 24 are power switches, which are semiconductor devices, such as MOSFETs, IGBTs, or triacs.

In the embodiment shown, the current measuring unit 22 comprises a shunt resistor 32 arranged in the current path 26, and a comparator 34. Alternatively, the protective assembly 20 may also include an operational amplifier circuit and a Hall-effect sensor instead of the shunt resistor.

In principle, the protective assembly 20 is set up to detect a current curve by means of the current measuring unit 22, characteristics of the detected current curve being determined.

For this purpose, an evaluation of the edges and/or the level of the detected current curve may be performed to detect a corresponding tripping case of the protective assembly 20. Similarly, the protective assembly 20 may be set up to recognize an occurring arc when the contacting between the vehicle contact unit and the ground contact unit 10 changes, so that a corresponding arc occurs between the respective contacts.

The protective assembly 20 can then drive the corresponding switch 24 so that the electric circuit is interrupted. Thus, the respective contact areas 16 which are assigned to the corresponding potential layer 18 assigned to the protective assembly 20 are appropriately protected, as the current flow is quickly interrupted.

Furthermore, it can be seen from FIG. 2 that the ground contact unit 10 comprises at least one additional switching unit 36, in particular a relay. The additional switching unit 36 is provided downstream of the protective assembly 20 in the direction of current flow, i.e. between the protective assembly 20 and the contact areas 16.

In other words, the at least one additional switching unit 36 is coupled to at least one of the contact areas 16, so that the additional switching unit 36 can accordingly electrically connect and disconnect at least one contact area 16 to/from the at least one potential layer 18 assigned to the contact area 16, so that there is a galvanic isolation in the interrupted state.

In the embodiment shown in FIG. 2, only one additional switching unit 36 is provided for all contact areas 16 of the corresponding potential layer 18, so that exactly one additional switching unit 36 is provided per potential layer 18. All contact areas 16 of the potential layer 18 are thus galvanically isolated together if the additional switching unit 36 is tripped or activated.

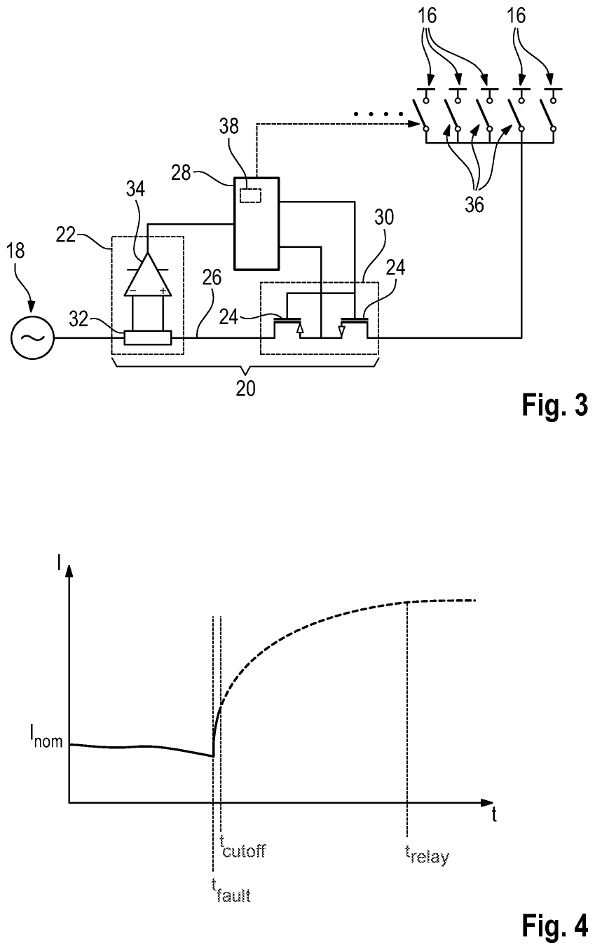

In contrast thereto, in the embodiment shown in FIG. 3, it is provided that the protective assembly 20 is assigned to a plurality of additional switching units 36, each contact area 16 having its own additional switching unit 36 assigned thereto. In this way, the individual contact areas 16 can be galvanically isolated individually by appropriately driving the correspondingly assigned additional switching unit 36.

In principle, a trigger circuit 38 may be provided for driving the at least one additional switching unit 36, which is in particular connected to the control and/or evaluation unit 28 or forms part thereof, as shown in the embodiments. Otherwise, the control and/or evaluation unit 28 drives the trigger circuit 38 accordingly.

In this respect, it may be provided that in the event of a detected fault, i.e. in the event of a tripping case such as a short circuit, a fault current or an (impending) overcurrent, the additional switching unit 36 (via the trigger circuit 38) and the at least one switch 24 of the protective assembly 20 are driven simultaneously.

As previously described, the tripping case can be determined via the protective assembly 20, in particular the current measuring unit 22 and the control and/or evaluation unit 28 coupled thereto, by detecting and evaluating characteristics of the current curve, for example an evaluation of the edges and/or the level of the detected current curve.

This is shown, for example, in FIG. 4, in which a tripping case can be recognized by the fact that the detected current value rises above a threshold value and at the same time a corresponding edge is present. The corresponding characteristics, i.e. the criteria used for the tripping case, are detected by the protective assembly 20 or the control and/or evaluation unit 28 at the time t_{fault}.

As described above, the switch 24 and the additional switching unit 36 are then driven (simultaneously).

The switch 24, which has a significantly better reaction time than the additional switching unit 36, reacts within a few hundred nanoseconds, so that the electric circuit is interrupted at the time t_{cutoff}, in particular before the current intensity has increased further.

In contrast thereto, the additional switching unit 36 would not respond until the time t_{relay}, at which time the current intensity would already have increased significantly, as illustrated by the dashed course of the current curve.

Therefore, the switch 24 reacts much faster than the additional switching unit 36, so that the additional switching unit 36 is initially protected from the load of the high current in case of tripping. In other words, the additional switching unit 36 can switch almost load-free.

However, the simultaneous driving of the additional switching unit 36 (via the trigger circuit 38) ensures that the additional switching unit 36 switches as promptly as possible to establish the galvanic isolation, so that protection against contact is ensured.

Basically, a combination of FIGS. 2 and 3 may also be provided, so that a central additional switching unit 36 is provided, as shown in FIG. 2, as well as the several additional switching units 36 which are respectively assigned to the contact areas 16.

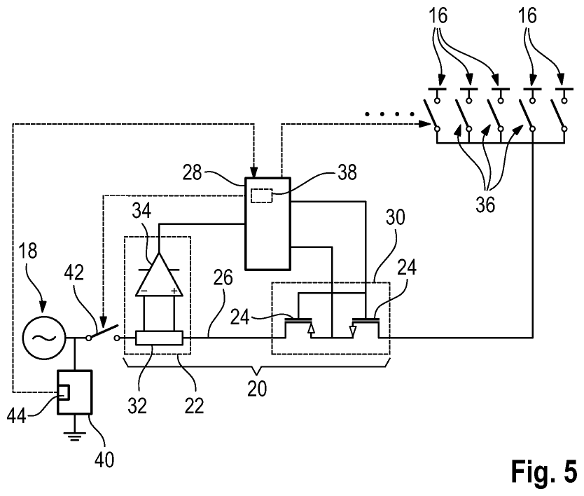

FIG. 5 shows a further embodiment which is based on that of FIG. 3.

In FIG. 5, a surge protection device 40 is furthermore provided, which is arranged downstream of a main terminal of the ground contact unit 10 which provides the at least one potential layer 18, in particular the phases L1, L2, L3, N.

Therefore, the surge protection device 40 is arranged upstream of the protective assembly 20, so that due to the surge protection device 40, the latter is protected from overvoltages which may occur during operation of the ground contact unit 10, in particular during a charging process. Due to the surge protection device 40, an area downstream of the surge protection device 40 is thus protected by the latter so as to correspond to overvoltage category III (“OVC III”).

An additional switching unit 42, which is configured as a main contactor, is arranged in this area. The main contactor in turn ensures that an area downstream of the main contactor is further protected, so that it corresponds to overvoltage category II (“OVC II”).

This means that the components of the ground contact unit 10 which are located downstream of the additional switching unit 42, i.e. the main contactor, only have to comply with the requirements of overvoltage category II, so that they have to be designed for a rated surge voltage of 2.5 kV. This thus applies to the protective assembly 20 and to the relays 36 and the contact areas 16.

Furthermore, the surge protection device 40 has at least one diagnostic contact 44 via which the surge protection device 40 is connected to the control and/or evaluation unit 28 in a signal-transmitting manner, so that diagnostic data of the surge protection device 40 can be transmitted to the control and/or evaluation unit 28 for evaluation.

Should the control and/or evaluation unit 28 determine during evaluation of the diagnostic data that the surge protection device 40 is worn or has signs of aging, the control and/or evaluation unit 28 can output a message to inform the user and/or operator of the ground contact unit 10.

Alternatively or additionally, the control and/or evaluation unit 28 can drive the additional switching unit 42, i.e. the main contactor, so that the latter interrupts the current path 26 to ensure that charging can no longer take place.

1. A ground contact unit for a vehicle battery charging system for an automatic conductive connection to a vehicle contact unit, wherein the ground contact unit has a plate-shaped base body, at least one potential layer, and a plurality of contact areas which are arranged on an exposed charging surface of the base body against which the vehicle contact unit can come into contact, and which are assigned to the at least one potential layer, wherein at least one protective assembly is assigned to the contact areas of the at least one potential layer, wherein the at least one protective assembly has a current measuring unit provided in a current path for current measurement and a switch which is arranged in the current path and is controlled, among others, depending on a result of the current measuring unit.

2. The ground contact unit according to claim 1, wherein the plurality of contact areas is assigned to exactly one potential layer, wherein the contact areas assigned to the exactly one potential layer are assigned to only one protective assembly.

3. The ground contact unit according to claim 1, wherein the protective assembly is set up to recognize a short circuit, an impending overcurrent and/or an overcurrent, wherein the protective assembly is set up to control the switch into its open position when the short circuit, the impending overcurrent and/or the overcurrent has been detected.

4. The ground contact unit according to claim 1, wherein the protective assembly is set up to detect a current curve and determine characteristics of the detected current curve.

5. The ground contact unit according to claim 1, wherein the protective assembly is set up to perform an evaluation of edges and/or of a level of a detected current curve and/or to recognize an occurring arc.

6. The ground contact unit according to claim 1, wherein the protective assembly comprises an operational amplifier circuit and/or a comparator and a shunt resistor and/or a Hall-effect sensor.

7. The ground contact unit according to claim 1, wherein the switch is a power semiconductor.

8. The ground contact unit according to claim 1, wherein the at least one protective assembly is set up to determine a differential current.

9. The ground contact unit according to claim 1, wherein the ground contact unit has at least one additional switching unit, wherein the at least one additional switching unit is coupled to at least one of the contact areas such that the additional switching unit is adapted to electrically connect and disconnect a corresponding at least one contact area to/from the at least one potential layer assigned to the contact area, so that there is a galvanic isolation in an interrupted state.

10. The ground contact unit according to claim 9, wherein only one additional switching unit is provided per potential layer.

11. The ground contact unit according to claim 9, wherein the at least one protective assembly is assigned to a plurality of additional switching units, wherein each contact area has its own additional switching unit assigned thereto.

12. The ground contact unit according to claim 9, wherein a trigger circuit is provided which is set up to drive the at least one additional switching unit.

13. The ground contact unit according to claim 1, wherein a surge protection device is provided which is arranged upstream of the protective assembly.

14. The ground contact unit according to claim 13, wherein an additional switching unit is arranged between the surge protection device and the protective assembly.

15. The ground contact unit according to claim 13, wherein the surge protection device has a diagnostic contact via which the surge protection device is connected in a signal-transmitting manner to a control and/or evaluation unit.

16. The ground contact unit according to claim 14, wherein the surge protection device has a diagnostic contact via which the surge protection device is connected in a signal-transmitting manner to a control and/or evaluation unit.

17. The ground contact unit according to claim 7, wherein the power semiconductor is a MOSFET, a triac or an IGBT.

18. The ground contact unit according to claim 9, wherein the at least one additional switching unit is a relay.

19. The ground contact unit according to claim 14, wherein the additional switching unit is a main contactor.
